(19) United States
(12) Patent Application Publication
(10) Pub. No.: US 2009/0187962 A1
(43) Pub. Date: Jul. 23, 2009

(54) METHODS, DEVICES, AND COMPUTER PROGRAM PRODUCTS FOR POLICY-DRIVEN ADAPTIVE MULTI-FACTOR AUTHENTICATION

(75) Inventors: Robert J. Brenneman, Stormville, NY (US); Michael E. Browne, Staatsburg, NY (US); William J. Huie, Poughkeepsie, NY (US); Sarah J. Sheppard, Poughkeepsie, NY (US); Kyle M. Smith, Melrose, MA (US)

Correspondence Address: CANTOR COLBURN LLP-IBM POUGHKEEPSIE, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/015,587

(22) Filed: Jan. 17, 2008

(51) Int. Cl. G06F 21/00; H04L 9/32; G06F 17/00

(52) U.S. Cl. 726/1; 726/5

(57) ABSTRACT

Embodiments of the invention include methods for providing policy-driven, adaptive, multi-factor authentication procedures. A pool of potential authentication challenges is defined. Each of the potential authentication challenges is assigned a category and a weighted difficulty level. One or more authentication challenges are selected from the pool of potential authentication challenges using one or more security policies that are based upon the assigned category and the assigned weighted difficulty level, wherein a quantity of authentication challenges is determined using the one or more security policies. One or more historical access patterns are utilized in conjunction with the selected one or more authentication challenges to authenticate a user, wherein the historical access patterns include at least one of an access time or an access location. One or more dummy challenges are used to authenticate the user.

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates generally to authentication procedures and, more particularly, to methods, devices, and computer program products for providing policy-driven, adaptive, multi-factor authentication procedures.

2. Description of Background

Authentication is the process of determining whether someone or something is, in fact, who or what it is declared to be. In private as well as public computer networks, authentication is commonly performed through the use of logon passwords. Knowledge of the password is assumed to guarantee that the user is authentic. Each user registers initially (or is registered by someone else), using an assigned or self-declared password. On each subsequent use, the user must know and use the previously declared password. One primary weakness in this approach is that passwords can be stolen, accidentally revealed, or forgotten. Accordingly, the password approach may be combined with one or more authentication challenges to provide a more stringent authentication process.

Existing authentication procedures utilize a fixed, predetermined number of authentication challenges, typically one challenge offered three times. With the proliferation of passwords, three attempts may not be enough. Likewise, answering a single challenge does not reveal much about the person attempting to authenticate and does not provide a high level of confidence that a user is who they claim to be. Moreover, the existing procedures do not take into consideration historical usage patterns and data which could be used to increase the level of confidence for an authentication procedure.

One recent advance is the use of multi-factor authentication (MFA), particularly in the banking industry to secure online sites. These sites are programmed to accept one or more user-specified authentication questions that are used to verify a user's identity on subsequent login attempts. However, the authentication questions specified by users are often trivial and only serve to weaken the security of the online site because there is no question or answer review. For example, a user might input ‘spell dog’ as their question, with an answer of ‘dog’. A question such as this does nothing to improve the security of the system and does not produce any confidence as to the identity of the user.

Another problem with MFA solutions is that they often utilize questions with related themes, thereby making it possible for unauthorized parties to answer all of the questions from a very limited amount of knowledge. For example, an illustrative financial website requests the name of the best man at the user's wedding and a potential follow-up question asks for the location of the wedding. There are potentially several hundred people that could know the answer to both of those questions (guests, friends, family, coworkers) from a very limited view into the user's life. Ideally, such questions should be wholly unrelated to make it more difficult to compromise the authentication procedures of an online website.

A need therefore exists for improved authentication procedures that utilize policy-driven, adaptive techniques, and that employ a multiplicity of factors for authentication. A solution that addresses, at least in part, the above and other shortcomings is desired.

### SUMMARY OF THE INVENTION

Embodiments of the invention include methods for providing policy-driven, adaptive, multi-factor authentication procedures. A pool of potential authentication challenges is defined. Each of the potential authentication challenges is assigned a category and a weighted difficulty level. One or more authentication challenges are selected from the pool of potential authentication challenges using one or more security policies that are based upon the assigned category and the assigned weighted difficulty level, wherein a quantity of authentication challenges is determined using the one or more security policies. One or more historical access patterns are utilized in conjunction with the selected one or more authentication challenges to authenticate a user, wherein the historical access patterns include at least one of an access time or an access location. One or more dummy challenges are also used to authenticate the user.

Devices and computer program products corresponding to the above-summarized methods are also described and claimed herein. Other methods and computer program products according to embodiments will be or become apparent to one with skill in the art upon review of the following drawings and detailed description. It is intended that all such additional methods and computer program products be included within this description, be within the scope of the present invention, and be protected by the accompanying claims.

### BRIEF DESCRIPTION OF THE DRAWINGS

Referring now to the drawings, wherein like elements are numbered alike in the several FIGURES:

FIG. 1 is an architectural block diagram showing an illustrative operational environment for the present invention.

FIG. 2 is a flowchart setting forth a first exemplary method for providing policy-driven, adaptive, multi-factor authentication procedures.

FIG. 3 is a flowchart setting forth a second exemplary method for providing policy-driven, adaptive, multi-factor authentication procedures.

The detailed description explains the preferred embodiments of the invention, together with advantages and features, by way of example with reference to the drawings.

### DETAILED DESCRIPTION OF THE INVENTION

In the following description, details are set forth to provide an understanding of the invention. In some instances, certain software, circuits, structures and methods have not been described or shown in detail in order not to obscure the invention. The term “data processing system” is used herein to refer to any machine for processing data, including the client/server computer systems and network arrangements described herein. The present invention may be implemented in any computer programming language provided that the operating system of the data processing system provides the facilities that may support the requirements of the present invention. The invention may be implemented with software, firmware, or hardware, or any of various combinations thereof.

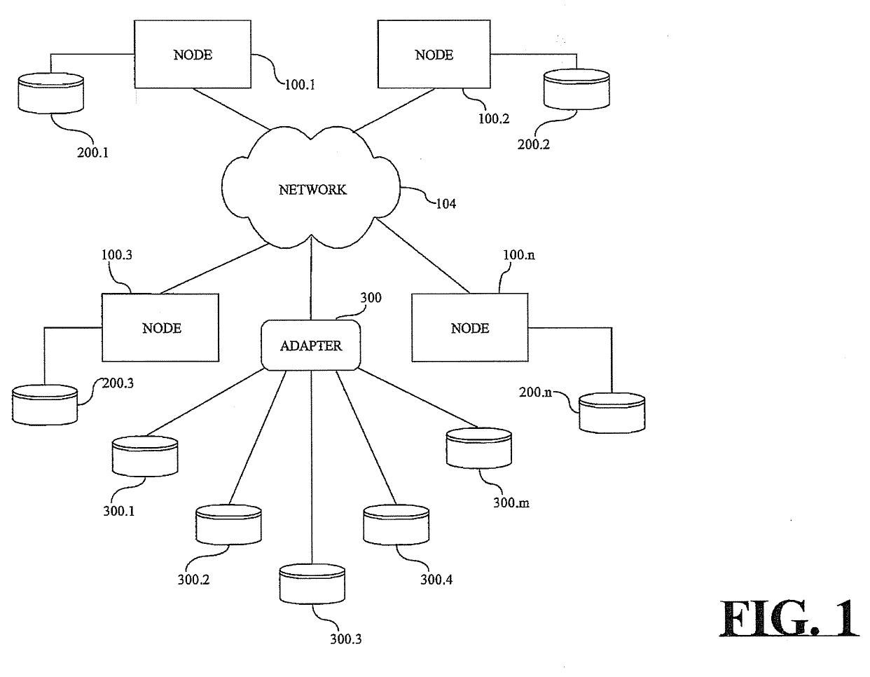

FIG. 1 is a block diagram setting forth an illustrative operational environment in which the present invention is employed. In particular, a plurality of authentication servers in the form of nodes 100.1 through 100.n are interconnected over a network 104. Nodes 100.3 through 100.n perform data input/output (I/O) operations on a storage device through a server node or over a local path. Nodes 100.1 through 100.n are operably coupled to network 104 through one or more adapters, cables, switches, or any of various combinations thereof.

In preferred embodiments of the present invention, each node 100.i represents an authentication server in the form of a processor node capable of communicating with other processor nodes using the publicly defined Transmission Control Protocol/Internet Protocol (TCP/IP) messaging protocol. While this protocol is referred to as an Internet Protocol, it should be noted that use of this term herein does not imply the existence of any Internet connection, nor does it imply dependence upon the Internet in any way. It is simply the name of a conveniently used, well characterized communication protocol suitable for use within a connected network of data processing nodes.

Each node 100.i may include one or more Central Processing Units (CPUs), some or all of which share memory with one another. This memory can be implemented using any computer readable storage medium such as electronic memory, magnetic memory, optical memory, or any of various combinations thereof. One or more of these CPUs are capable of implementing an operating system. Each node 100.i may be connected locally to a non-volatile storage device such as a Direct Access Storage Device (DASD) unit or other similar storage device 200.i, where i is an integer greater than or equal to 2, but less than or equal to n. Storage device 200.i typically comprises a rotating magnetic disk storage unit, sometimes referred to as a disk drive. However, the scope of the present invention includes any nonvolatile storage mechanism capable of holding data files. The number n of nodes 100.i is not critical. Furthermore, not everything operably coupled to network 104 has to be a data processing node. A plurality of DASD storage devices 300.1 through 300.m are connected to network 104 using, for example, a network adapter 300 for maintaining communication between DASD storage devices 300.1 to 300.m and network 104.

The nodes 100.i may contain additional software and hardware, a description of which is not necessary for understanding the invention. One or more of the nodes 100.i has stored therein data representing sequences of instructions which, when executed, cause the methods described hereinafter to be performed. Thus, one or more of the nodes 100.i include computer executable programmed instructions for directing the system of FIG. 1 to implement any of the embodiments of the present invention.

The programmed instructions may be embodied in at least one hardware, firmware, or software module resident in a memory associated with the one or more Central Processing Units (CPUs) of one or more nodes 100.i. This memory can be implemented using any computer readable storage medium such as electronic memory, magnetic memory, optical memory, or any of various combinations thereof. Alternatively or additionally, the programmed instructions may be embodied on a computer readable medium (such as a CD disk or floppy disk) which may be used for transporting the programmed instructions to the memory of the node 100.i. Alternatively or additionally, the programmed instructions may be embedded in a computer-readable, signal or signal-bearing medium that is uploaded to the node 100.i by a vendor or supplier of the programmed instructions, and this signal or signal-bearing medium may be downloaded through an interface to the node 100.i from the network 104 by end users or potential buyers.

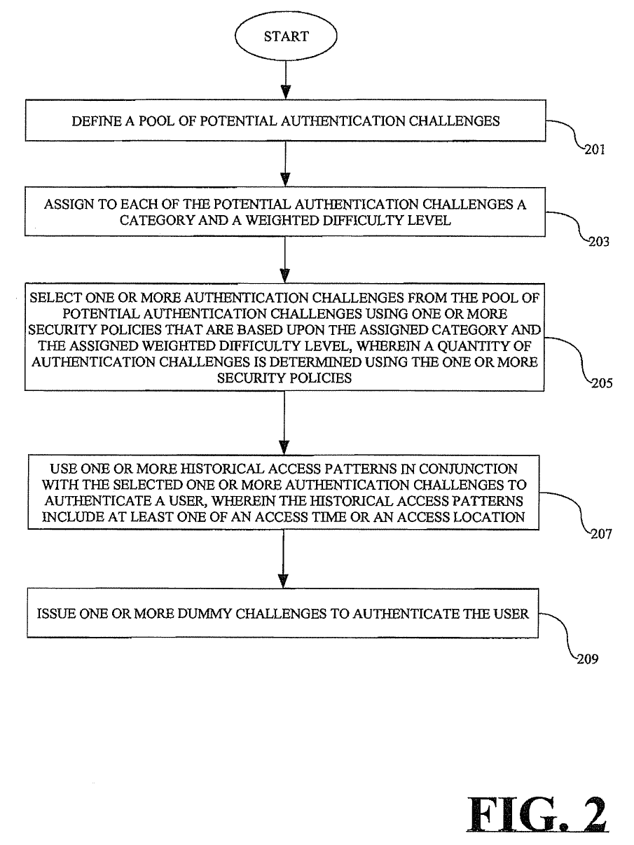

FIG. 2 is a flowchart setting forth a first exemplary method for providing policy-driven, adaptive, multi-factor authentication procedures. The procedure commences at block 201 where a pool of potential authentication challenges is defined. Each of the potential authentication challenges is assigned a category and a weighted difficulty level (block 203). One or more authentication challenges are selected from the pool of potential authentication challenges using one or more security policies that are based upon the assigned category and the assigned weighted difficulty level, wherein a quantity of authentication challenges is determined using the one or more security policies (block 205). One or more historical access patterns are utilized in conjunction with the selected one or more authentication challenges to authenticate a user, wherein the historical access patterns include at least one of an access time or an access location (block 207). One or more dummy challenges are also used to authenticate the user (block 209).

Illustratively, the security policies of block 205 are defined by an administrator based on one or more business rules. By way of example, these security policies could consider any of: (A) a location from which a user is initiating the authentication procedure, such as a public kiosk or a secure terminal; (B) a date and a time at which a user is initiating the authentication procedure, such as whether the procedure is being initiated outside of normal business hours or outside of a range of times that the user typically initiates the authentication procedure; (C) a number of times that the user has attempted to log in but failed; (D) a historic access pattern for the user; or (E) a communication channel presently being used by the user.

A security policy outputs one or more conditions precedent in order for authentication to tale place (“What will it take for me to grant access?”). The policies themselves could be defined in a language such as Web Services Policy language (WS-Policy) or an XML policy language used by a policy management framework. One example of a policy management framework is IBM's Policy Management for Autonomic Computing (PMAC) toolkit. PMAC provides tools for creating, storing and evaluating suitable policies.

The utilization of one or more historical access patterns described with reference to block 207 may, but need not, be performed using a combination of Bayesian interference and creating an N-dimensional index of access history properties (date/time, access method, physical location, network address, etc.), where N is a positive integer. Each property is a dimension in the overall space, and each access attempt can be considered a point mass in the space, with the different property values determining the coordinates and the number of identical attempts in the past determining the mass. The current access attempt is also plotted and the Euclidean distance between it and its nearest neighbor is calculated. The resulting distance is plugged into Newton's gravitational attraction formula and the resulting “gravity” between the two points is computed. The stronger the force, the closer the access attempt matches the historic trend.

The dummy challenges discussed with reference to block 209 are implemented as follows. Dummy challenges are trick questions which an authorized user has previously been instructed to answer incorrectly. If a user correctly answers the challenge, the system knows that they are not who they claim to be. One example of a dummy challenge is: what does 2+2 equal? In order to permit a user to be authenticated using this challenge, any answer other than 4 would be acceptable. These questions would not serve on their own to authenticate the user, but would be inserted into the set of challenges that the user is presented with in order to weed out impostors or identity thieves.

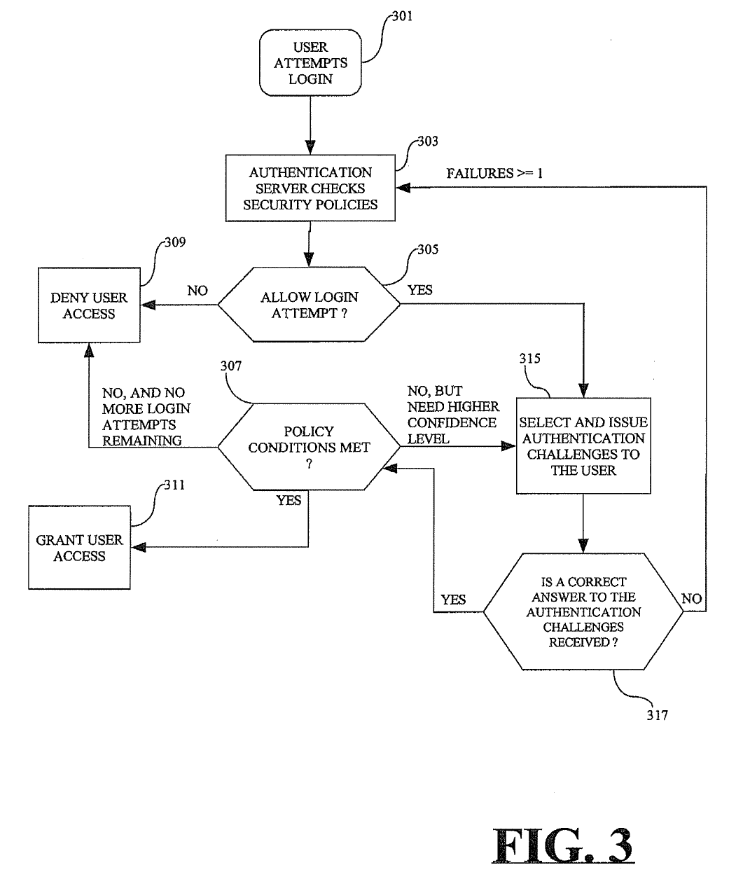

FIG. 3 is a flowchart setting forth a second exemplary method for providing policy-driven, adaptive, multi-factor authentication procedures. A user attempts to log in (block 301). An authentication server checks security policies (block 303). A test is performed at block 305 to ascertain whether or not the log in attempt of block 301 should be allowed. If not, the user is denied access (block 309). The affirmative branch from block 305 leads to block 315 where authentication challenges are selected and issued to the user. Next, at block 317, a test is performed to ascertain whether or not a correct answer to the authentication challenge was received. If not, the program loops back to block 303. The affirmative branch from block 317 leads to block 307 where a test is performed to ascertain whether or not security policy conditions have been met. If so, the user is granted access (block 311). The negative branch from block 307 leads to block 309 (described previously) if no more login attempts remain, or to block 315 (described previously) if a higher level of authentication confidence is needed.

Block 303 may be performed by consulting a policy repository stored in a computer readable storage medium. Security policies are selected that are in scope and whose preconditions are met. A minimum level of confidence is determined that is required by all of the security policies in a resulting set of security policies. This minimum level of confidence represents the minimum level of confidence for which an authentication or login attempt will be permitted to occur. A number of remaining log in or authentication attempts is determined, and a user's access history and access patterns is checked. Examples of illustrative policies include: (A) If a resource being accessed is a production server, a minimum level of confidence of 10 is needed; (B) If a resource is being accessed outside of business hours, a minimum level of confidence of 15 or greater is required; (C) If a user is connecting from a secure terminal, a minimum confidence level of 2 is required; and (D) If a user is connecting via rsh, a minimum confidence level of 4 is required.

The methods described in conjunction with any of FIGS. 2 and 3 provide a system by which an authentication server may vary the number and types of challenges given to the user in order to authenticate them based on administrator-defined policies, making it more secure and allowing the system to have a greater level of confidence that the user is who they claim to be. Dummy challenges may also be used to weed out impostors (questions designed to be answered incorrectly). Challenges are assigned weighted difficulty levels by an administrator in order to prevent trivial challenges from being used. The method also takes advantage of system or data access patterns (such as access time, the location from which the user is accessing the system, etc.) and adjusts the challenges based on the user's history.

The methods described in conjunction with any of FIGS. 2 and 3 may, but need not, utilize administrator-defined metadata associated with each challenge to randomly select a variety of questions in order to limit the chance that similar questions (or similar themes of questions) will be presented to the user. Information is acquired that identifies a physical and/or logical access location for the user. The access times of each of a plurality of individual users may be recorded. An administrator may be used to assign weights to the challenges, to assign one or more categories or themes to the challenges, and to select dummy challenges for weeding out impostors. The historical data access patterns of the user is employed as part of the authorization process and will also dynamically increase the security level of the system based on a level of perceived risk. Moreover, at least one of the difficulty of challenges, or the number of challenges, may be increased based on the level of perceived risk. This level of perceived risk may be based upon user location, time of transaction, number of previous attempts and type of transaction.

The capabilities of the present invention can be implemented in software, firmware, hardware or some combination thereof. As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for providing policy-driven, adaptive, multi-factor authentication procedures, the method including:
defining a pool of potential authentication challenges;
assigning each of the potential authentication challenges a category and a weighted difficulty level;
selecting one or more authentication challenges from the pool of potential authentication challenges using one or more security policies that are based upon the assigned category and the assigned weighted difficulty level, wherein a quantity of authentication challenges is determined using the one or more security policies; and
utilizing one or more historical access patterns in conjunction with the selected one or more authentication challenges to authenticate a user, wherein the historical access patterns include at least one of an access time or an access location.

2. The method of claim 1 further including using one or more dummy challenges to authenticate the user.

3. The method of claim 1 wherein the one or more security policies are defined using one or more business rules.

4. The method of claim 1 wherein the one or more security policies consider one or more of: (A) a location from which a user is initiating the authentication procedure; (B) a date and a time at which a user is initiating the authentication procedure; (C) a number of times that the user has attempted to log in or authenticate but failed; (D) a historic access pattern for the user; or (E) a communication channel presently being used by the user.

5. The method of claim 1 wherein the one or more security policies output one or more conditions precedent for authenticating the user.

6. The method of claim 1 wherein the one or more security policies are defined using a language including at least one of Web Services Policy language (WS-Policy) or an XML policy language used by IBM's Policy Management for Autonomic Computing (PMAC) toolkit.

7. The method of claim 1 wherein utilizing one or more historical access patterns is performed using a combination of Bayesian interference and creating an N-dimensional index of access history properties where N is a positive integer.

8. A computer program product for providing policy-driven, adaptive, multi-factor authentication procedures, the computer program product including a storage medium readable by a processing circuit and storing instructions for execution by the processing circuit for facilitating a method including:
defining a pool of potential authentication challenges;
assigning each of the potential authentication challenges a category and a weighted difficulty level;
selecting one or more authentication challenges from the pool of potential authentication challenges using one or more security policies that are based upon the assigned category and the assigned weighted difficulty level, wherein a quantity of authentication challenges is determined using the one or more security policies; and
utilizing one or more historical access patterns in conjunction with the selected one or more authentication challenges to authenticate a user, wherein the historical access patterns include at least one of an access time or an access location.

9. The computer program product of claim 8 further including instructions for using one or more dummy challenges to authenticate the user.

10. The computer program product of claim 8 wherein the one or more security policies are defined using one or more business rules.

11. The computer program product of claim 8 wherein the one or more security policies consider one or more of: (A) a location from which a user is initiating the authentication procedure; (B) a date and a time at which a user is initiating the authentication procedure; (C) a number of times that the user has attempted to log in or authenticate but failed; (D) a historic access pattern for the user; or (E) a communication channel presently being used by the user.

12. The computer program product of claim 8 wherein the one or more security policies output one or more conditions precedent for authenticating the user.

13. The computer program product of claim 8 wherein the one or more security policies are defined using a language including at least one of Web Services Policy language (WS-Policy) or an XML policy language used by a policy management framework.

14. The computer program product of claim 8 wherein utilizing one or more historical access patterns is performed using a combination of Bayesian interference and creating an N-dimensional index of access history properties where N is a positive integer.

15. An authentication server for providing policy-driven, adaptive, multi-factor authentication procedures, the authentication server including:
an input mechanism for receiving a pool of potential authentication challenges;
the input mechanism capable of accepting inputs indicative of an assigned category and an assigned weighted difficulty level for each of a plurality of potential authentication challenges in the pool of potential authentication challenges;
a processing mechanism, operatively coupled to the input mechanism, the processing mechanism being programmed to select one or more authentication challenges from the pool of potential authentication challenges using one or more security policies that are based upon the assigned category and the assigned weighted difficulty level, wherein a quantity of authentication challenges is determined using the one or more security policies; wherein the processing mechanism is further programmed to utilize one or more historical access patterns in conjunction with the selected one or more authentication challenges to authenticate a user, wherein the historical access patterns include at least one of an access time or an access location.

16. The authentication server of claim 15 wherein the input mechanism is capable of accepting one or more dummy challenges for authenticating the user.

17. The authentication server of claim 15 wherein the one or more security policies are defined using one or more business rules.

18. The authentication server of claim 15 wherein the one or more security policies consider one or more of: (A) a location from which a user is initiating the authentication procedure; (B) a date and a time at which a user is initiating the authentication procedure; (C) a number of times that the user has attempted to log in or authenticate but failed; (D) a historic access pattern for the user; or (E) a communication channel presently being used by the user.

19. The authentication server of claim 15 wherein the one or more security policies are defined using a language including at least one of Web Services Policy language (WS-Policy) or an XML policy language used by a policy management framework.

20. The authentication server of claim 15 wherein utilizing one or more historical access patterns is performed using a combination of Bayesian interference and creating an N-dimensional index of access history properties where N is a positive integer.
